(19) United States
(12) Patent Application Publication
(10) Pub. No.: US 2019/0288959 A1
(43) Pub. Date: Sep. 19, 2019

(54) COMMUNICATION APPARATUS WITH REDUNDANT COMMUNICATION CIRCUITS

(71) Applicants: KABUSHIKI KAISHA TOSHIBA, Tokyo (JP); TOSHIBA ELECTRONIC DEVICES & STORAGE CORPORATION, Tokyo (JP)

(72) Inventor: Hirohisa KUSANO, Mitaka Tokyo (JP)

(21) Appl. No.: 16/120,400

(22) Filed: Sep. 3, 2018

(30) Foreign Application Priority Data
Mar. 15, 2018 (JP) 2018-048346

(51) Int. Cl. H04L 12/939; H04L 12/931; H04L 12/823; H04L 12/721; H04L 12/741

(52) U.S. Cl. CPC H04L 49/552; H04L 49/555; H04L 49/70; H04L 12/4641; H04L 45/66; H04L 45/74; H04L 49/354; H04L 47/32

(57) ABSTRACT

A communication apparatus includes a first communication circuit, a second communication circuit, and a control circuit. The control circuit is configured to generate a first and a second frame both including same payload data and addressed to a same destination communication apparatus, the first frame including a first route information corresponding to the first communication circuit and the second frame including a second route information corresponding to the second communication circuit, and transmit the first frame to the first communication circuit for transmission to the destination communication apparatus, and the second frame to the second communication circuit for transmission to the destination communication apparatus.

### CROSS-REFERENCE TO RELATED APPLICATION

This application is based upon and claims the benefit of priority from Japanese Patent Application No. 2018-048346, filed Mar. 15, 2018, the entire contents of which are incorporated herein by reference.

### FIELD

Embodiments described herein relate generally to a communication apparatus with redundant communication circuits.

### BACKGROUND

In related art, a communication system using an Ethernet® communication standard is known. In the communication system, a plurality of network switches is provided on a communication path connecting two communication apparatuses. In a case where a failure occurs on the communication path, in order to bypass the communication path by another communication path, a method of providing redundant communication paths is disclosed. To select between redundant communication paths, a method using a spanning tree protocol (STP, IEEE 802.1D) is disclosed.

At the same time, it has been considered to use the Ethernet standards not only in consumer appliances but in the automobile field. In the automobile field, functional safety based on the ISO 26262 standard may be required.

However, in the configuration in related art, while a communication path between two network switches may be made redundant, a communication path between a communication apparatus and a switch is not made redundant. For this reason, a communication apparatus in related art cannot perform redundant path communication with an Ethernet frame, and as a result, reliability cannot be improved.

### DESCRIPTION OF THE DRAWINGS

FIG. 1 shows a diagram illustrating a configuration of a communication system including a communication apparatus according to an embodiment.

FIG. 2 shows a diagram illustrating a configuration of a communication apparatus including duplicate Ethernet circuits.

FIG. 3 shows a diagram for explaining a structure of an Ethernet frame according to an embodiment.

FIGS. 4-5 depict a flowchart for explaining an example of a flow of processing when duplicated frames are received.

FIG. 6 shows a diagram for explaining a structure of a frame including VLAN information.

### DETAILED DESCRIPTION

Embodiments provide a communication apparatus capable of improving reliability by duplicating an Ethernet frame and transmitting the duplicated frames.

In general, according to one embodiment, a communication apparatus includes a first communication circuit, a second communication circuit, and a control circuit. The control circuit is configured to generate a first and a second frame both including same payload data and addressed to a same destination communication apparatus, the first frame including a first route information corresponding to the first communication circuit and the second frame including a second route information corresponding to the second communication circuit, and transmit the first frame to the first communication circuit for transmission to the destination communication apparatus, and the second frame to the second communication circuit for transmission to the destination communication apparatus.

Hereinafter, embodiments will be described in detail with reference to the drawings.

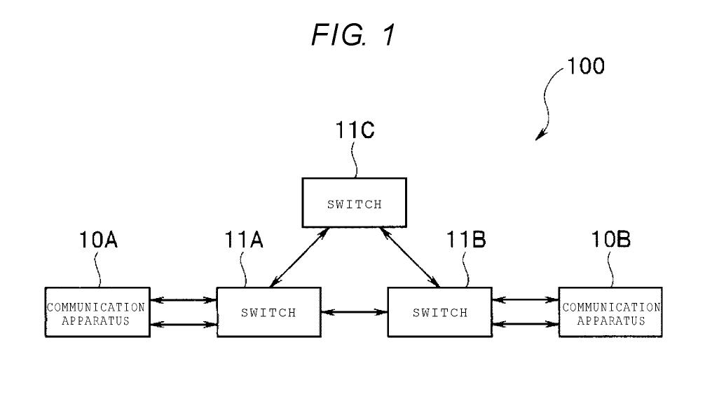

First, a configuration of a communication system including a communication apparatus according to an embodiment will be described with reference to FIG. 1. FIG. 1 shows a diagram illustrating a configuration of a communication system including a communication apparatus according to an embodiment.

A communication system 100 according to the embodiment includes a communication apparatus 10A, a communication apparatus 10B, a switch 11A, a switch 11B, and a switch 11C. In the present embodiment, communication paths between the communication apparatus 10A and the communication apparatus 10B is made redundant by a plurality of switches 11A, 11B, and 11C. That is, even in a case where a failure occurs on a communication path between the switch 11A and the switch 11B, the communication path can be bypassed by a communication path from the switch 11A to the switch 11C and a communication path from the switch 11C to the switch 11B.

In addition, in the present embodiment, a communication path between the communication apparatus 10A and the switch 11A is made redundant, and a communication path between the communication apparatus 10B and the switch 11B is made redundant. Thereby, reliability in data communication between the communication apparatus 10A and the communication apparatus 10B is improved.

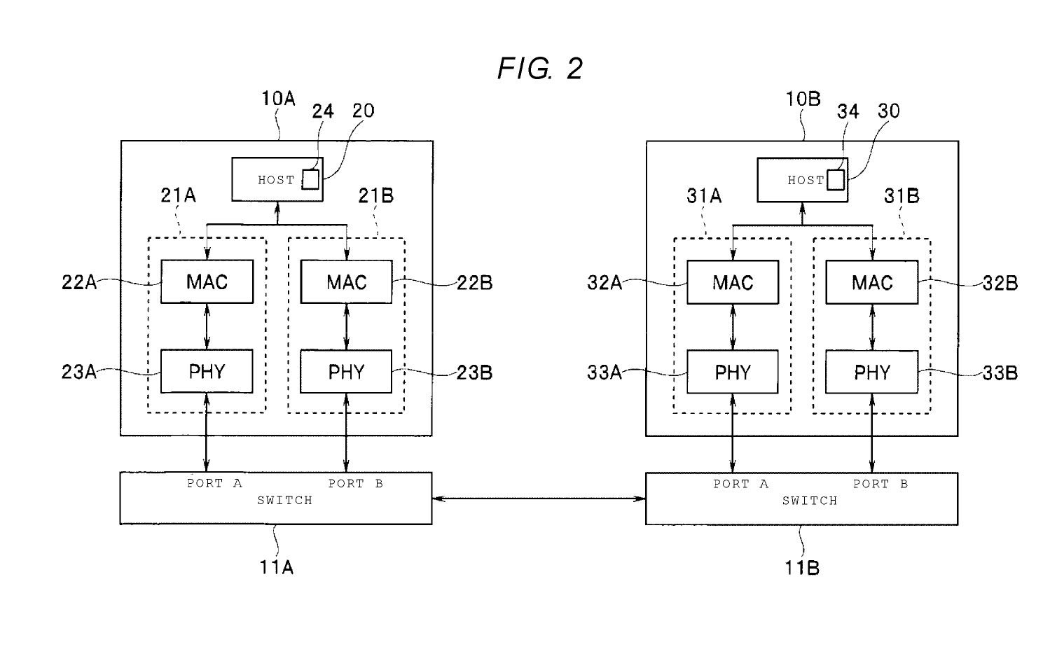

FIG. 2 shows a diagram illustrating a configuration of a communication apparatus including redundant Ethernet circuits.

The communication apparatus 10A includes a host 20 and redundant Ethernet circuits (e.g., in an embodiment, two Ethernet circuits 21A and 21B). The communication apparatus 10A may include three or more redundant Ethernet circuits.

The Ethernet circuit 21A includes a media access control (MAC) layer 22A that performs layer 2 processing and a physical (PHY) layer 23A that performs layer 1 processing. Similarly, the Ethernet circuit 21B includes a MAC layer 22B that performs layer 2 processing and a PHY layer 23B that performs layer 1 processing. The host 20 includes a memory 24 that can store various data.

The communication apparatus 10B has the same configuration as that of the communication apparatus 10A, and includes a host 30 and redundant Ethernet circuits (in an embodiment, two Ethernet circuits 31A and 31B). The communication apparatus 10B may include three or more redundant Ethernet circuits.

The Ethernet circuit 31A includes a MAC layer 32A that performs layer 2 processing and a PHY layer 33A that performs layer 1 processing. Similarly, the Ethernet circuit 31B includes a MAC layer 32B that performs layer 2 processing and a PHY layer 33B that performs layer 1 processing. The host 30 includes a memory 34 that can store various data.

Data communication can be performed between the communication apparatus 10A and the communication apparatus 10B. In the following description, a case where data is transmitted from the communication apparatus 10A to the communication apparatus 10B will be described.

The host 20 of the communication apparatus 10A as a transmitter converts data into Ethernet frames, and outputs the Ethernet frames to the Ethernet circuits 21A and 21B. The same frame output from the host 20 is passed through a path A of the Ethernet circuit 21A and a path B of the Ethernet circuit 21B. A frame output from the Ethernet circuit 21A is transmitted to the switch 11B via a port A of the switch 11A. In addition, a frame output from the Ethernet circuit 21B is transmitted to the switch 11B via a port B of the switch 11A.

In a case of transmitting a frame received from the communication apparatus 10A as a transmitter to the communication apparatus 10B as a receiver, the switch 11B transmits the frame to a path A of the Ethernet circuit 31A or a path B of the Ethernet circuit 31B of the communication apparatus 10B as a receiver.

The general switch (e.g., switching hub) 11A stores a MAC address of the passed frame in a MAC address table. In the MAC address table, a MAC address of the connected communication apparatus is stored by being correlated with a port of the switch. By the MAC address table, the switch 11A transmits a received frame from a MAC address of a transmission destination to only a specific port.

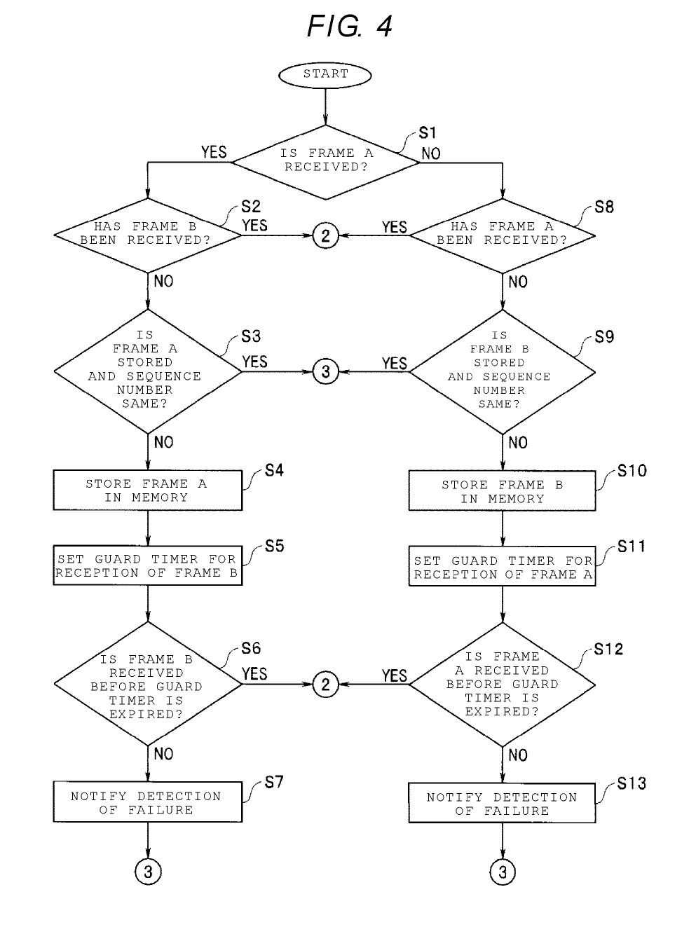

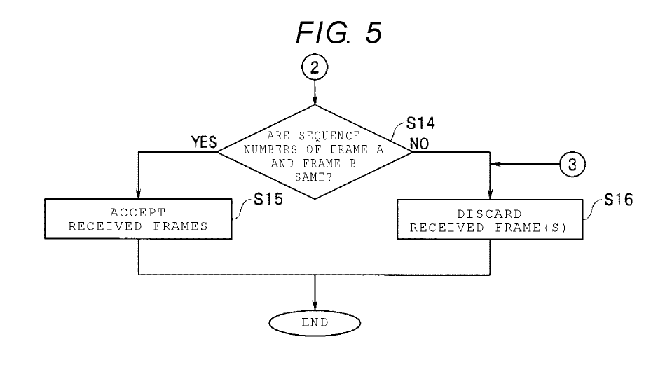

Here, in a case where a MAC address of a transmission destination is a broadcast address or multicast address other than an unicast address, the switch 11A simultaneously receives a frame from the path A and the path B. This processing will be described with reference to FIG. 4 and FIG. 5 to be described.

The communication apparatus 10B as a receiver compares frames received through the path A and the path B of the communication apparatus 10A as a transmitter, and when the received frames are the same frame, accepts the received frames.

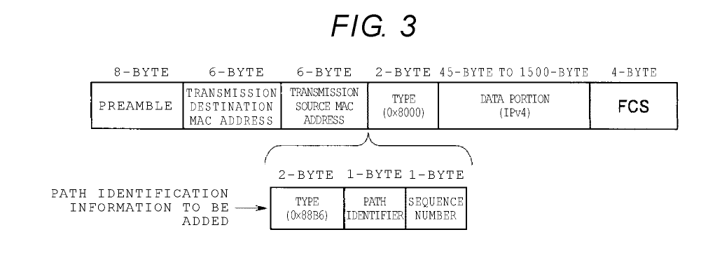

Whether a frame is transmitted through either the path A of the Ethernet circuit 21A or the path B of the Ethernet circuit 21B is determined by path identification information added to header information of an Ethernet frame. Here, the path identification information to be added will be described with reference to FIG. 3.

FIG. 3 shows a diagram for explaining a structure of an Ethernet frame according to an embodiment.

As illustrated in FIG. 3, a normal Ethernet frame includes an 8-byte preamble indicating a start of a frame, a 6-byte transmission destination MAC address, a 6-byte transmission source MAC address, a 2-byte Ether type, a data portion of 45 byte to 1500 byte, and a 4-byte frame check sequence (FCS) for detecting a frame error.

As an example, in a case of a frame of an internet protocol version 4 (IPv4) packet, the Ether type is set to 0x8000, and IPv4 data is stored in the data portion.

In an embodiment, the host 20 is implemented by a control circuit or a controller including at least a processor and a memory, and the host 20 adds the path identification information to the frame. Specifically, in a frame according to the present embodiment, 4-byte path identification information is added to a portion before the Ether type by the host 20. For example, for a 2-byte Ether type in a first half of the path identification information, 0x88B6 of IEEE 802 (i.e., local experiment Ether type) defined by the IEEE 802 number of Internet Assigned Numbers Authority (IRNA) is used as the Ether type for path information.

In addition, for a 2-byte Ether type in a second half of the path identification information, one-byte path identifier and one-byte sequence number are used. For example, in a case where a frame passes through the path A of the Ethernet circuit 21A, the path identifier is set to 0x00, and in a case where a frame passes through the path B of the Ethernet circuit 21B, the path identifier is set to 0x01. Thereby, it is possible to distinguish whether the frame passes through the path A of the Ethernet circuit 21A or the path B of the Ethernet circuit 21B.

For example, after a first frame is transmitted to the communication apparatus 10B through the path A and the path B, when a second frame is transmitted to the communication apparatus 10B through the path A and the path B, a sequence number obtained by increment of a sequence number of the first frame is set as a sequence number of the second frame. Thereby, the first frame and the second frame are distinguished.

The host 20 outputs a path identifier of a first frame to the path A of the Ethernet circuit 21A, as “0x00”, and outputs a path identifier of a first frame to the path B of the Ethernet circuit 21B, as “0x01”. Thus, the host 20 duplicates the same frame, and transmits the duplicated frames to the communication apparatus 10B as a receiver.

Thereafter, the host 20 increases the sequence number, outputs a path identifier of a second frame to the path A of the Ethernet circuit 21A, as “0x00”, and outputs a path identifier of a second frame to the path B of the Ethernet circuit 21B, as “0x01”.

The communication apparatus 10B as a receiver receives the duplicated frames through the path A of the Ethernet circuit 21A and the path B of the Ethernet circuit 21B, compares path identification information of the duplicated frames, and accepts the received frames when they are the same frame.

Here, processing when the duplicated frames are received will be described with reference to FIG. 4 and FIG. 5. FIG. 4 and FIG. 5 show flowcharts for explaining an example of a flow of processing when the duplicated frames are received. Processing of FIG. 4 and FIG. 5 is started when the communication apparatus 10B as a receiver receives a frame transmitted from the communication apparatus 10A as a transmitter.

First, in processing of S1, the host 30 of the communication apparatus 10B as a receiver refers to a path identifier of a received frame, and determines whether or not a frame passing through the path A of the Ethernet circuit 21A of the communication apparatus 10A as a transmitter (referred to as “frame A” for short) is received (S1). Normally, in a case where frames are transmitted in an order of the path A and the path B by the communication apparatus 10A as a transmitter, the communication apparatus 10B as a receiver receives the frames in the order of the frames passing through the path A and the path B. On the other hand, the order may be reversed depending on processing states of the switches 11A and 11B. For this reason, the host 30 of the communication apparatus 10B first determines whether a frame passing through the path A of the Ethernet circuit 21A is received or a frame passing through the path B of the Ethernet circuit 21B (referred to as “frame B” for short) is received.

Next, in a case where it is determined that a frame passing through the path A is received (YES in S1), in processing of S2, the host 30 determines whether or not a frame passing through the path B has been received. In a case where it is determined that the frame B has been received (YES in S2), the host 30 proceeds to processing of S14 in FIG. 5.

On the other hand, in a case where it is determined that the frame B has not been received (NO in S2), in processing of S3, the host 30 determines whether or not a sequence number of the frame A is the same as a sequence number stored in the memory 34. In a case where it is determined that a sequence number of the frame A is the same as a stored sequence number (YES in S3), the host 30 proceeds to processing of S16 in FIG. 5, and discards the received frame. That is, in a case where the same frame A is received, the host 30 determines that the frame A is a broadcast frame or a multicast frame, and discards the same frame.

On the other hand, in a case where it is determined that a sequence number of the frame A is not the same as a stored sequence number (NO in S3), in processing of S4, the host 30 stores the frame A in the memory. In processing of S5, the host 30 sets a guard timer for reception of the frame B. In the processing of S5, the host 30 sets a guard timer to an estimated maximum time until the frame B is received.

In processing of S6, the host 30 determines whether or not the frame B is received before the guard timer for reception of the frame B is expired. In a case where it is determined that the frame B is received before the guard timer for reception of the frame B is expired (YES in S6), the host 30 proceeds to processing of S14 in FIG. 5.

On the other hand, in processing of S7, in a case where it is determined that the frame B is not received until the guard timer for reception of the frame B is expired (NO in S6), the host 30 returns a notification of detection of a failure. Thereafter, the host proceeds to processing of S16 in FIG. 5, and discards the received frame.

The guard timer is a timer which is set considering that a frame including the same sequence number may be lost in the middle of a communication path or a failure may occur on the path A or the path B on a transmission side. In a case where the guard timer is expired, the host 30 returns a notification of detection of a failure, and then discards the received frame.

On the other hand, in a case where it is determined that the frame A is not received in the processing of S1 (NO in S1), that is, in a case where it is determined that the frame B is received, in processing of S8, the host 30 determines whether or not the frame A has been received. In a case where it is determined that the frame A has been received (YES in S8), the host 30 proceeds to processing of S14 in FIG. 5.

On the other hand, in a case where it is determined that the frame A has not been received (NO in S8), in processing of S9, the host 30 determines whether or not a sequence number of the frame B is the same as a stored sequence number. In a case where it is determined that a sequence number of the frame B is the same as a stored sequence number (YES in S9), the host 30 proceeds to processing of S16 in FIG. 5, and discards the received frame. That is, in a case where the same frame B is received, the host 30 determines that the frame B is a broadcast frame or a multicast frame, and discards the same frame.

On the other hand, in a case where it is determined that a sequence number of the frame B is not the same as a stored sequence number (NO in S9), in processing of S10, the host 30 stores the frame B in the memory 34. In processing of S11, the host 30 sets a guard timer for reception of the frame A. In the processing of S11, the host 30 sets a guard timer to an estimated maximum time until the frame A is received.

In processing of S12, the host 30 determines whether or not the frame A is received before the guard timer for reception of the frame A is expired. In a case where it is determined that the frame A is received before the guard timer for reception of the frame A is expired (YES in S12), the host 30 proceeds to processing of S14 in FIG. 5.

On the other hand, in a case where it is determined that the frame A is not received until the guard timer for reception of the frame A is expired (NO in S12), in processing of S13, the host 30 performs notification of detection of a failure. Thereafter, the host 30 proceeds to processing of S16 in FIG. 5, and discards the received frame.

In FIG. 5, in a case where the frame A and the frame B are received, in processing of S14, the host 30 determines whether or not sequence numbers of the frame A and the frame B are the same. In a case where it is determined that sequence numbers of the frame A and the frame B are the same (YES in S14), in processing of S15, the host 30 accepts the received frames, and ends processing. On the other hand, in a case where it is determined that sequence numbers of the frame A and the frame B are not the same (NO in S14), in processing of S16, the host 30 discards the received frames, and ends processing.

In a case where the host 30 performs notification of detection of a failure, the host 30 proceeds to processing of S16 and discards the received frame. On the other hand, the host 30 may proceed to processing of S15, and select one received frame among the received frame A and the received frame B for subsequent processing of the contained data.

In addition, in processing of S14, the host 30 determines whether or not sequence numbers of the received frame A and the received frame B are the same. On the other hand, in addition to the sequence numbers, the host 30 may determine whether or not pieces of data in the data portions of the frame A and the frame B are the same. Since comparing pieces of data in the data portions requires processing power, the host 30 may omit the comparison step as necessary.

As described above, the communication apparatus 10A as a transmitter includes the Ethernet circuits 21A and 21B, duplicates an Ethernet frame by the Ethernet circuits 21A and 21B, and transmits the duplicate frames to the communication apparatus 10B as a receiver. In this configuration, the communication apparatus 10A according to an embodiment can improve reliability by duplicating an Ethernet frame and transmitting the duplicated frames.

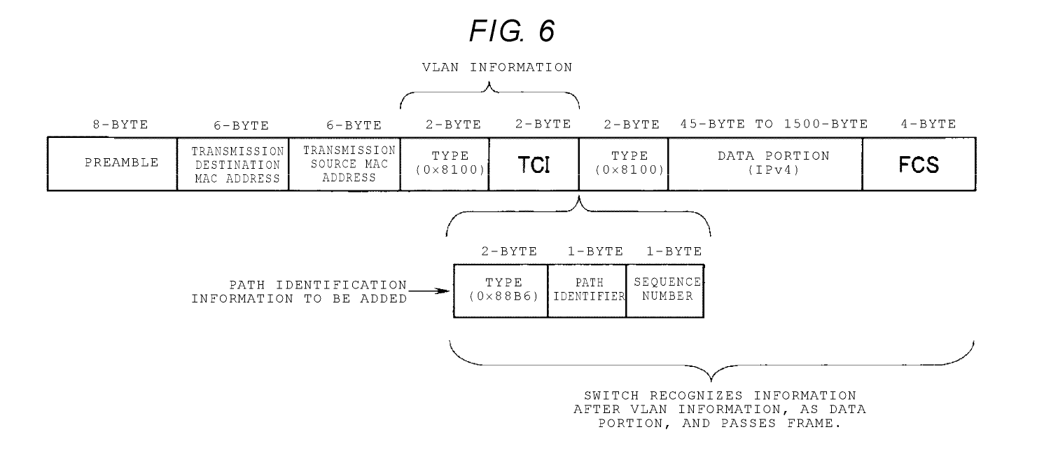

For example, in a case where the switch 11A is a switch which supports virtual local area network (VLAN) information, when the path identification information illustrated in FIG. 3 is added to a frame, it is considered that the frame cannot pass through the switch 11A which supports VLAN information. This is because there is a possibility that the switch 11A discards a frame including path information which cannot be recognized by the switch 11A. For this reason, a frame including VLAN information has a structure illustrated in FIG. 6.

FIG. 6 shows a diagram for explaining a structure of a frame including VLAN information.

As illustrated in FIG. 6, an Ethernet frame including VLAN information includes 4-byte VLAN information in a portion after a MAC address of a transmission source. The 4-byte VLAN information includes a 2-byte Ether type and 2-byte tag control information (TCI).

For the Ethernet frame including the VLAN information, the host 20 adds 4-byte path identification information to a portion after the VLAN information. The 4-byte path identification information is the same as the path identification information of FIG. 3, and includes a 2-byte Ether type, a 1-byte path identifier, and 1-byte sequence number.

With the above configuration, in the case where the switch 11A is a switch which supports VLAN information, the switch 11A recognizes information after the VLAN information, as a data portion. Thus, the switch 11A can pass the frame illustrated in FIG. 6.

In the flow chart of the present specification, an execution order of each step may be changed, a plurality of steps may be executed at the same time, or the steps may be executed in a different order for each execution as long as a feature of each step is not changed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication apparatus comprising:
a first communication circuit;
a second communication circuit; and
a control circuit configured to:
generate a first and a second frame both including same payload data and addressed to a same destination communication apparatus, the first frame including a first route information corresponding to the first communication circuit and the second frame including a second route information corresponding to the second communication circuit, and
transmit the first frame to the first communication circuit for transmission to the destination communication apparatus, and the second frame to the second communication circuit for transmission to the destination communication apparatus.

2. The communication apparatus according to claim 1, wherein the control circuit is configured to receive third and fourth frames from another communication apparatus in that order through the first and second communication circuits, and accept the third and fourth frames based on when the third and fourth frames are received relative to each other, and route information and sequence numbers included in the third and fourth frames.

3. The communication apparatus according to claim 1, wherein the control circuit is configured to accept third and fourth frames received from another communication apparatus in that order if: (i) route information included in the third and fourth frames are different; (ii) the third and fourth frames are both received within a predetermined time window; and (iii) sequence numbers included in the third and fourth frames are the same.

4. The communication apparatus according to claim 3, wherein the control circuit is configured to discard the third and fourth frames and return a notification of detection of failure to said another communication apparatus if: (i) the route information included in the third and fourth frames are different; and (ii) the third and fourth frames are not both received within the predetermined time window.

5. The communication apparatus according to claim 3, wherein the control circuit is configured to discard the third and fourth frames and return a notification of detection of failure to said another communication apparatus if: (i) the route information included in the third and fourth frames are different; (ii) the third and fourth frames are both received within the predetermined time window; and (iii) the sequence numbers included in the third and fourth frames are not the same.

6. The communication apparatus according to claim 3, wherein the control circuit is configured to discard the fourth frame if: (i) the route information included in the third and fourth frames are the same; and (ii) the sequence numbers included in the third and fourth frames are the same.

7. The communication apparatus according to claim 3, wherein the control circuit is configured to start a timer when the third frame is received and stop the timer when the fourth frame is received to determine whether or not the third and fourth frames are both received within the predetermined time window.

8. A method carried out by a communication apparatus having first and second communication circuits, the communication method comprising:
generating a first and a second frame both including same payload data and addressed to a same destination communication apparatus, the first frame including a first route information corresponding to the first communication circuit and the second frame including a second route information corresponding to the second communication circuit; and
transmitting the first frame to the first communication circuit for transmission to the destination communication apparatus, and the second frame to the second communication circuit for transmission to the destination communication apparatus.

9. The method according to claim 8, further comprising:
receiving third and fourth frames from another communication apparatus in that order through the first and second communication circuits; and
accepting the third and fourth frames based on when the third and fourth frames are received relative to each other, and route information and sequence numbers included in the third and fourth frames.

10. The method according to claim 8, further comprising:
accepting third and fourth frames received from another communication apparatus in that order if: (i) route information included in the third and fourth frames are different; (ii) the third and fourth frames are both received within a predetermined time window; and (iii) sequence numbers included in the third and fourth frames are the same.

11. The method according to claim 9, further comprising:
discarding the third and fourth frames and returning a notification of detection of failure to said another communication apparatus if: (i) the route information included in the third and fourth frames are different; and (ii) the third and fourth frames are not both received within the predetermined time window.

12. The method according to claim 9, further comprising:
discarding the third and fourth frames and returning a notification of detection of failure to said another communication apparatus if: (i) the route information included in the third and fourth frames are different; (ii) the third and fourth frames are both received within the predetermined time window; and (iii) the sequence numbers included in the third and fourth frames are not the same.

13. The method according to claim 11, further comprising:
discarding the fourth frame if: (i) the route information included in the third and fourth frames are the same; and (ii) the sequence numbers included in the third and fourth frames are the same.

14. The method according to claim 11, further comprising:
starting a timer when the third frame is received and stopping the timer when the fourth frame is received to determine whether or not the third and fourth frames are both received within the predetermined time window.

15. A communication system comprising:
a first communication apparatus that includes a first communication circuit, a second communication circuit, and a first control circuit; and
a second communication apparatus that includes a second control circuit, wherein
the first control circuit is configured to generate a first and a second frame both including same payload data and addressed to the second communication apparatus, the first frame including a first route information corresponding to the first communication circuit and the second frame including a second route information corresponding to the second communication circuit, and transmit the first frame to the first communication circuit for transmission to the second communication apparatus, and the second frame to the second communication circuit for transmission to the second communication apparatus, and
the second control circuit is configured to accept the first and second frames based on when the first and second frames are received relative to each other.

16. The communication system according to claim 15, wherein the second communication apparatus further includes third and fourth communication circuits through which the first and second frames are received.

17. The communication system according to claim 15, wherein the second control circuit is configured to accept first and second frames if the first and second frames are both received within a predetermined time window.

18. The communication apparatus according to claim 15, wherein the second control circuit is configured to discard first and second frames and return a notification of detection of failure to said first communication apparatus if the first and second frames are not both received within the predetermined time window.

19. The communication apparatus according to claim 15, wherein the control circuit is configured to discard a third frame received from the first communication apparatus between receipt of the first and second frames if: (i) the route information included in the first and third frames are the same; and (ii) the sequence numbers included in the first and third frames are the same.

20. The communication apparatus according to claim 15, wherein the second control circuit is configured to start a timer when the first frame is received and stop the timer when the second frame is received to determine whether or not the first and second frames are both received within the predetermined time window.
